(19) United States
(12) Patent Application Publication
(10) Pub. No.: US 2017/0138336 A1
(43) Pub. Date: May 18, 2017

(54) MULTI-TIERED WIND TURBINE APPARATUS

(71) Applicant: Kuo-Chang Huang, Tainan City (TW)

(72) Inventor: Kuo-Chang Huang, Tainan City (TW)

(21) Appl. No.: 15/337,539

(22) Filed: Oct. 28, 2016

(30) Foreign Application Priority Data
Nov. 13, 2015 (TW) 104137445

(51) Int. Cl. F03D 1/02; F03D 9/00; F03D 9/25; F03D 1/06

(52) U.S. Cl. CPC F03D 1/025; F03D 1/0633; F03D 9/002; F03D 9/25

(57) ABSTRACT

A multi-tiered wind turbine apparatus includes a support unit, a rotary shaft and a plurality of first blade modules. The rotary shaft is rotatably connected to the support unit. The blade modules are connected to the rotary shaft and are axially spaced apart from each other along the rotary shaft. Each blade module includes a plurality of blades that extend outwardly and radially from the rotary shaft and that are angularly spaced apart from each other. The blades are capable of driving the rotary shaft to rotate in a first direction when propelled by a wind.

### CROSS-REFERENCE TO RELATED APPLICATION

This application claims priority of Taiwanese Application No. 104137445, filed on Nov. 13, 2015.

### FIELD

The disclosure relates to a wind turbine apparatus, and more particularly to a multi-tiered wind turbine apparatus.

### BACKGROUND

There are various forms of electrical generators that convert wind and ocean energies or tidal power into electrical energy. As shown in FIG. 1, a conventional horizontal-axis wind turbine apparatus includes an elevated mount base 90, a shaft 91 horizontally and rotatably extending through the elevated mount base 90, and a blade module 92 mounted on an end of the shaft 91 away from the elevated mount base 90. The blade module 92 includes three angularly spaced-apart blades 921 connected to the shaft 91. When the blades are propelled by wind to drive rotation of the shaft 91, the conventional horizontal-axis wind turbine apparatus can generate electrical energy.

In order to efficiently produce electrical energy, each blade 921 has to have a length ranging between 50 and 75 meters so as to increase the surface area thereof for encountering the wind and to thereby provide sufficient rotational torque of the shaft 91.

Because of the long length of the blades 921, a height difference between the topmost and bottommost ends of the blade module 92 can be greater than 100 meters. Since the speed of wind varies at different heights, the greater the height difference, the greater the wind speed difference is. During operation of the conventional horizontal-axis wind turbine apparatus, since the blade module 92 spanning a considerably wide range of heights must encounter a wide range of levels of wind forces, the blade module 92 may wobbles, fail to operate smoothly and even become damaged.

Further, the greater the length of each blade 921, the larger the torque can be generated by the blades 921. However, a large torque can deform and even damage the blades 921 and the shaft 91 at their junction.

### SUMMARY

Therefore, an object of the disclosure is to provide a multi-tiered wind turbine apparatus that can enhance smoothness of operation and that is durable and not prone to damage and deformation by wind.

According to the present disclosure, a multi-tiered wind turbine apparatus includes a support unit, a first rotary shaft and a plurality of first blade modules.

The first rotary shaft is rotatably connected to the support unit.

The first blade modules are connected to the first rotary shaft and are axially spaced apart from each other along the first rotary shaft. Each of the first blade modules includes a plurality of first blades that extend outwardly and radially from the first rotary shaft and that are angularly spaced apart from each other. The first blades are capable of driving the first rotary shaft to rotate in a first direction when propelled by wind.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating conventional horizontal-axis wind turbine apparatus;

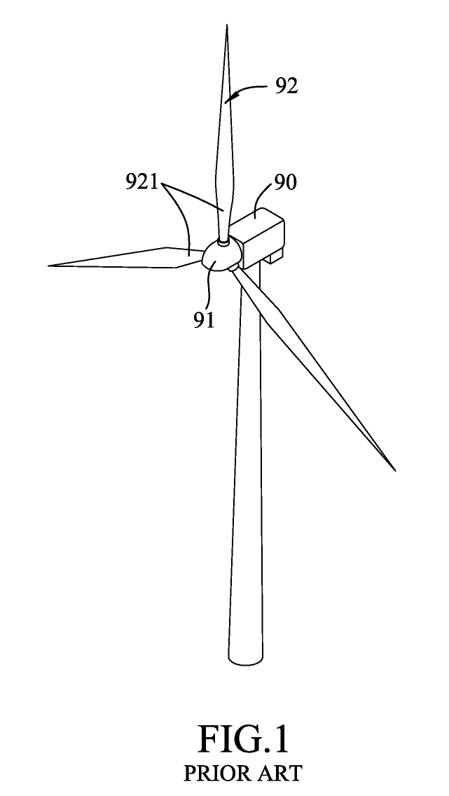

FIG. 2 is a fragmentary perspective view of a multi-tiered wind turbine apparatus according to a first embodiment of the present disclosure;

FIG. 3 is a partly sectional side view of the first embodiment;

FIG. 4 is a fragmentary front view of the first embodiment in an operation state;

FIG. 5 is a fragmentary perspective view of a multi-tiered wind turbine apparatus according to a second embodiment of the present disclosure;

FIG. 6 is a partly sectional side view of the second embodiment;

FIG. 7 is a fragmentary front view of the second embodiment in an operation state; and

FIG. 8 is a partly sectional side view of a multi-tiered wind turbine apparatus according to a third embodiment of the present disclosure.

### DETAILED DESCRIPTION

Before the disclosure is described in greater detail, it should be noted that like elements are denoted by the same reference numerals throughout the disclosure.

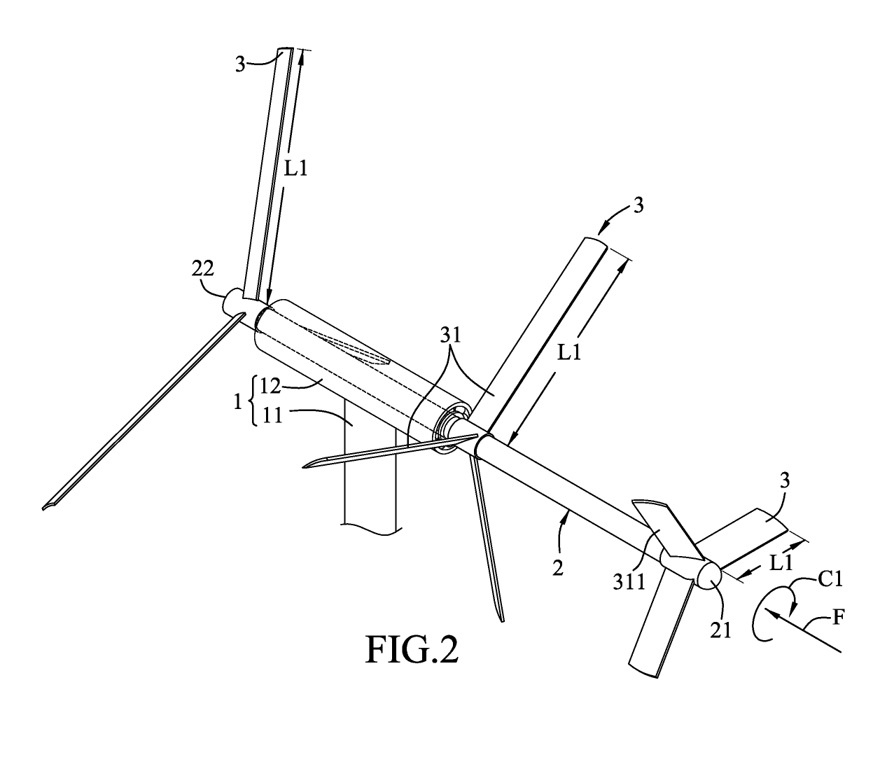

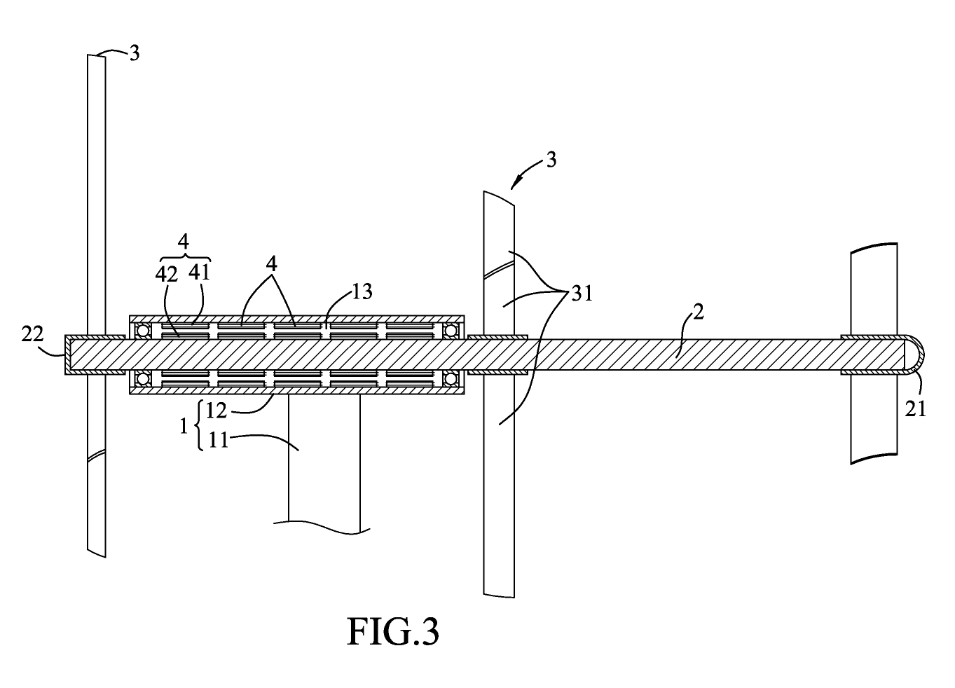

Referring to FIGS. 2 to 4, a multi-tiered wind turbine apparatus according to a first embodiment of the present disclosure is the horizontal axis type and includes a support unit 1, a first rotary shaft 2, three first blade modules 3 and a plurality of unidirectional electric generator modules 4.

The first rotary shaft 2 is rotatably connected to the support unit 1. In this embodiment, the support unit 1 includes a prop 11 and a mount base 12 located on a top of the prop 11. The mount base 12 defines a first power generating space 13. In practice, the mount base 12 is designed to be rotatable horizontally with respect to the ground and can be driven by a rudder plate (not shown) to move toward a position of best wind reception.

The first rotary shaft 2 rotatably extends lengthwise through the first power generating space 13. The first rotary shaft 2 has an upwind end 21 and a downwind end 22 opposite to said upwind end 21. It should be noted that the mount base 12 consists of a plurality of bearings allowing the first rotary shaft 2 to rotatably extend through the first power generating space 13.

The three first blade modules 3 are connected to the first rotary shaft 2 and are axially spaced apart from each other between the upwind and downwind ends 21, 22 along the first rotary shaft 2. Each first blade module 3 includes a plurality of first blades 31 that extend outwardly and radially from the first rotary shaft 2 and that are angularly spaced apart from each other. The first blades 31 are capable of driving the first rotary shaft 2 to rotate in a first direction (C1) when propelled by wind.

To be easily propelled by the wind, each first blade 31 has a wind-deflecting surface 311 that is inclined with respect to the direction (F) of the wind. When the wind strikes the wind-deflecting surfaces 311 of the first blades 31, the wind-deflecting surfaces 311 of the first blades 31 deflect the direction of the wind. The reaction forces of the wind on the wind-deflecting surfaces 311 of the first blades 31 drive rotation of the first blades 31.

Each first blade 31 has a radial length (L1) along a radial direction from the first rotary shaft 2. The radial lengths (L1) of the first blades 31 of the first blade modules 3 increase from the upwind end 21 to the downwind end 22. That is to say, the radial lengths (L1) of the first blades 31 of the first blade modules 3 located proximate to the downwind end 22 are the longest, and the lengths (L1) of the first blades 31 of the first blade modules 3 located proximate to the upwind end 21 are the shortest. As such, the first blades 31 of the first blade modules 3 located proximate to the upwind end 21 will not entirely block passage of the wind toward the first blades 31 of the first blade modules 3 located proximate to the downwind end 22, and wind reception areas of the first blades 31 of the first blade modules 3 located proximate to the downwind end 22 are increased.

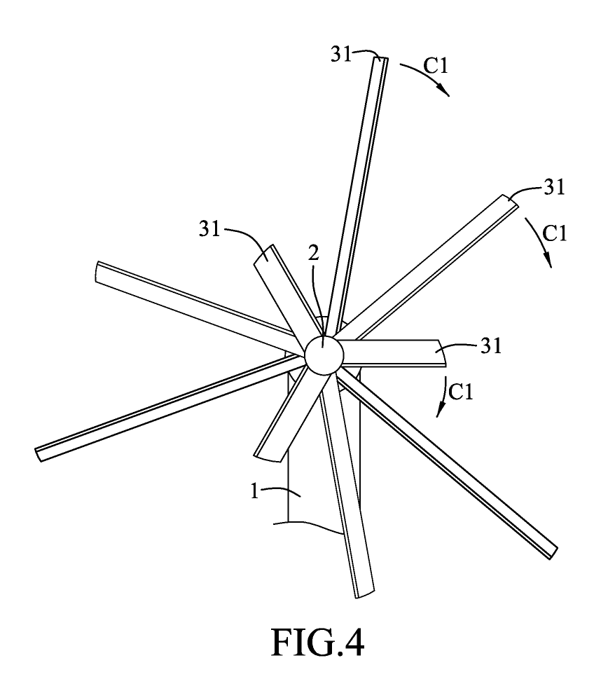

Further, the first blades 31 of each of the first blade modules 3 are staggered from the first blades 31 of the remaining of the first blade modules 3. Because there are three first blade modules 3 each of which includes three first blades 31 in this embodiment, the first blades 31 of each of the first modules 3 are angularly spaced apart from each other by 360°/3=120°. The first blades 31 of every two adjacent ones of the first modules 3 are staggered from each other by 360°/(3×3)=40°. As shown in FIG. 4, the first blades 31 of the first modules 3 are radially distributed about the first rotary shaft 2. The first blades 31 are arranged in such a manner that, when the first blades 31 of the first blade modules 3 are projected on a plane perpendicular to the first rotary shaft 2, radial lengths (L1) of the first blades 31, which extend radially between every two shortest ones of the first blades 31, increase in an angular direction opposite to the first direction (C1) of the first rotary shaft 2. Because the first blades 31 of the first blade modules 3 are staggered from each other, the wind is able to sequentially pass through and propel the first blades 31 from the upwind end 21 to the downwind end 22.

While, in this embodiment, the first blades 31 of every two adjacent ones of the first modules 3 are staggered from each other by 40°, the stagger angle of the first blades 31 of every two adjacent ones of the first modules 3 may vary depending on the number of the first blade modules 3 and the number of the first blades 31 in each first blade module 3. For example, when there are four first blade modules 3 each including five first blades 31, the first blades 31 of every two adjacent ones of the first modules 3 are staggered from each other by 360°/(4×5)=18°.

The unidirectional electric generator modules 4 are disposed in the first power generating space 13 and spaced apart from each other along the first rotary shaft 2. Each unidirectional electric generator module 4 includes a known stator 41 mounted on an inner surface of the mount base 12, and a known rotor 42 mounted on the first rotary shaft 2. When the first blades 31 are propelled by the wind and drive rotation of the first rotary shaft 2 in the first direction (C1), relative rotation of the stators 41 and rotors 42 produces an induced current. In practice, the multi-tiered wind turbine apparatus of the present disclosure may include only one unidirectional electric generator module 4.

Because the radial lengths (L1) of the first blades 31 of the first blade modules 3 gradually increase from the upwind end 21 to the downwind end 22, and because the first blades 31 of the first blade modules 3 are staggered from each other, wind currents are able to pass through the first blade module 3 at the upwind end 21 to propel the first blade module 3 at the downwind end 22.

Since the surface areas of the first blades 31 to face the wind are increased by increasing the number of the first blades 31 of each first blade module 3, the radial lengths (L1) of the first blades 31 may be reduced in comparison with the conventional wind turbine apparatus, while the first blades 31 can still provide sufficient rotational torque.

As described hereinbefore, because the height from bottom to top of each first blade module 3 is reduced in the embodiment, compared to the conventional wind turbine, the multi-tiered wind turbine apparatus in the embodiment can alleviate the problems occurring in the conventional wind turbine, in which the blade module 92 is subjected to a relatively wide range of varying levels of wind force. In addition, the multi-tiered wind turbine apparatus in the embodiment is not prone to damage and deformation.

Further, because the first blade modules 3 are axially spaced apart from each other along the first rotary shaft 2, torsion force produced by the first blade modules 3 may be evenly distributed on the first rotary shaft 2 so as to reduce torsional deformation of the first rotary shaft 2.

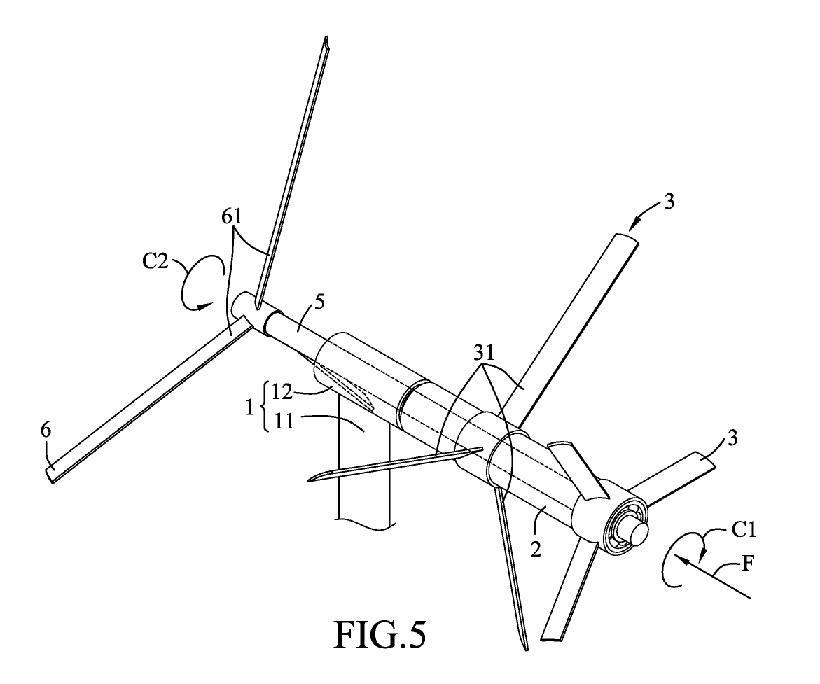

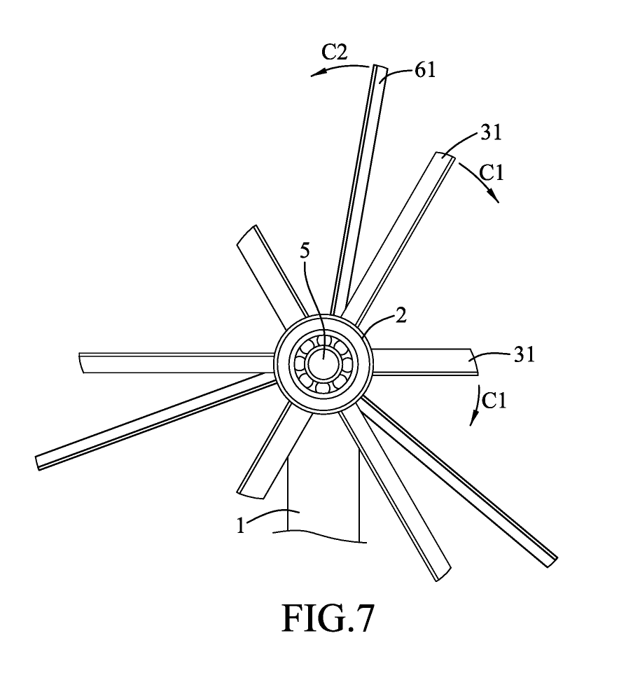

FIGS. 5 to 7 illustrate a multi-tiered wind turbine apparatus according to a second embodiment of the present disclosure. The difference of the second embodiment is that, in addition to the first blade modules 3 and the first rotary shaft 2, the second embodiment includes a second rotary shaft 5, a second blade module 6 and a plurality of first dual directional electric generators 7. The number of the first blade modules 3 is two. The unidirectional electric generators 4 of the first embodiment are replaced by the dual directional electric generators 7.

In the second embodiment, the second rotary shaft 5 is rotatably connected to and extends lengthwise through the mount base 12. The first rotary shaft 2 is a tubular shaft that is disposed outside of the mount base 12. The second rotary shaft 5 is coaxial with and spaced apart from the first rotary shaft 2. Specifically, the first rotary shaft 2 is sleeve around the second rotary shaft 5 in a spaced apart manner, and cooperates therewith to define a second power generating space 50. The second rotary shaft 5 has a portion for mounting the second blade module 6.

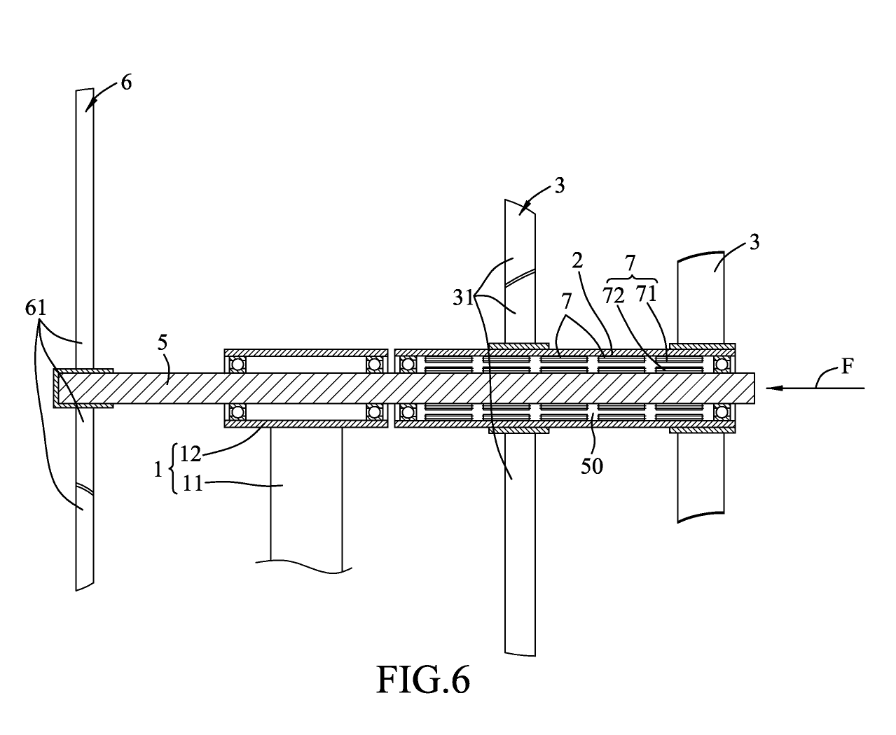

The second blade module 6 has a plurality of angularly spaced-apart second blades 61 each of which radially and outwardly extends from the second rotary shaft 5. The second blades 61 are capable of driving the second rotary shaft 5 to rotate in a second direction (C2) reverse to the first direction (C1) when propelled by the wind. As shown in FIG. 6, because the second blade module 6 is downstream from the first blade modules 3, and because each second blade 61 has a radial length greater than the radial length of each first blade 31, the first blades 31 of the first blade modules 3 will not block passage of the wind toward the second blades 61 of the second blade module 6.

The first dual directional electric generators 7 are disposed in the second power generating space 50 and are axially spaced apart from each other along the second rotary shaft 5. Each first dual directional electric generator 7 includes a first rotor 71 that is connected to and rotatable along with the first rotary shaft 2 in the first direction (C1), and a second rotor 72 that is connected to and rotatable along with the second rotary shaft 5 in the second direction (C2).

In this embodiment, both the first and second rotors 71, 72 include armature cores and windings. In use, the first rotors 71 first generate a magnetic field. When the first blade modules 3 propelled by the wind drive the first rotary shaft 2 to rotate in the first direction (C1), and the second blade modules 6 propelled by the wind drives the second rotary shaft 5 to rotate in the second direction (C2), the first and second rotors (71, 72) are rotated relative to each other such that the first dual directional electric generators 7 output an induced current through a plurality of sliding rings (now shown).

In this embodiment, the first and second rotors 71, 72 are reversely rotated relative to each other. In comparison with the first embodiment, the advantage of the second embodiment resides in that the second embodiment can enhance the efficiency of electrical power generation because the relative rotation of the first and second rotors 71, 72 is faster than the rotation of the rotor 42 relative to the stator 41 of the first embodiment. If the material costs are to be saved, the number of the first and second rotors 71, 72 maybe reduced to generate the same electrical power as that of the first embodiment.

Alternatively, the second rotary shaft 5 may be the tubular shaft, and the first rotary shaft 2 may be rotatably disposed in the second rotary shaft 5 in a spaced apart manner. Further, the second blade module 6 may be disposed upstream of each first blade module 3. In such a case, the length of each second blade 61 is smaller than the length of each first blade 31.

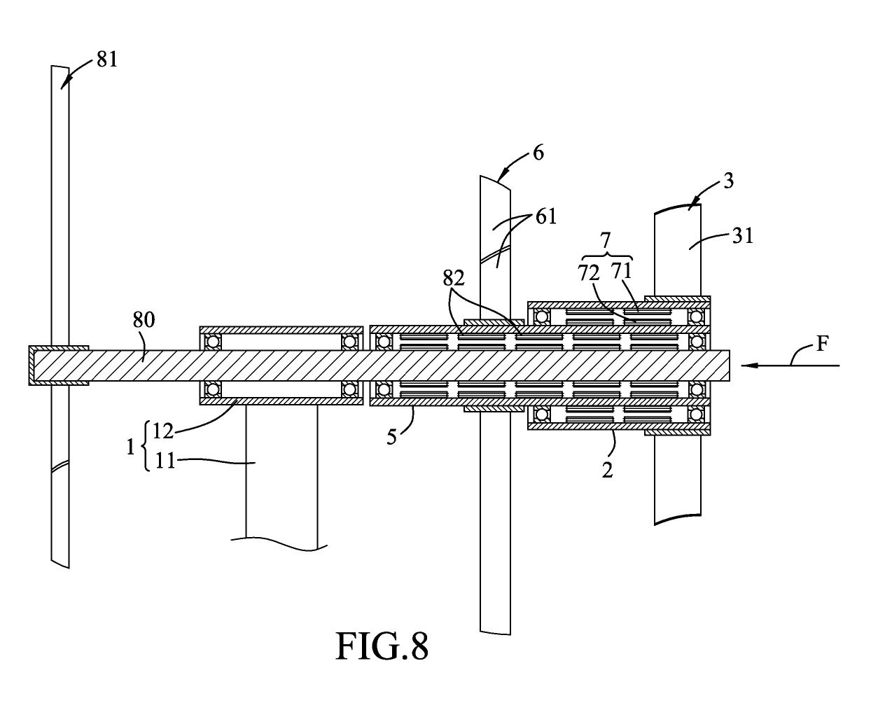

FIG. 8 illustrates a multi-tiered wind turbine apparatus according to a third embodiment of the present disclosure. The difference of the third embodiment resides in that the third embodiment further includes a third rotary shaft 80, a third blade module 81 and a plurality of second dual directional electric generators 82. In this embodiment, the second rotary shaft 5 is disposed outside of the mount base 12 and the third rotary shaft 80 is rotatably connected to and extends lengthwise through the mount base 12. The second rotary shaft 5 is a tubular shaft that is rotatably disposed around the third rotary shaft 80 in a spaced apart manner. The third rotary shaft 80 has a portion to mount the third blade module 81.

When the third blade module 81 propelled by the wind drives the third rotary shaft 80 to rotate in the first direction (C1), the first and second dual directional electric generators 7, 82 will output the induced currents.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A multi-tiered wind turbine apparatus comprising:
a support unit;
a first rotary shaft rotatably connected to said support unit; and
a plurality of first blade modules that are connected to said first rotary shaft and that are axially spaced apart from each other along said first rotary shaft, each of said first blade modules including a plurality of first blades that extend outwardly and radially from said first rotary shaft and that are angularly spaced apart from each other, said first blades being capable of driving said first rotary shaft to rotate in a first direction when propelled by wind.

2. The multi-tiered wind turbine apparatus as claimed in claim 1, wherein said first rotary shaft has an upwind end and a downwind end opposite to said upwind end, said first blade modules being spaced apart from each other between said upwind and downwind ends, radial lengths of said first blades of said first blade modules increasing from said upwind end to said downwind end.

3. The multi-tiered wind turbine apparatus as claimed in claim 2, said first blades of each of said first blade modules are staggered from said first blades of the remaining of said first blade modules.

4. The multi-tiered wind turbine apparatus as claimed in claim 3, wherein, when said first blades of said first blade modules are projected on a plane perpendicular to said first rotary shaft, said radial lengths of said first blades, which extend between every two shortest ones of said first blades, increase in an angular direction opposite to the first direction of said first rotary shaft.

5. The multi-tiered wind turbine apparatus as claimed in claim 1, further comprising a second rotary shaft and a second blade module, said second rotary shaft being coaxial with and spaced apart from said first rotary shaft, said second blade module having a plurality of angularly spaced-apart second blades each of which radially and outwardly extends from said second rotary shaft, said second blades being capable of driving said second rotary shaft to rotate in a second direction reverse to the first direction when propelled by the wind.

6. The multi-tiered wind turbine apparatus as claimed in claim 5, further comprising at least one first dual directional electric generator, said first and second rotary shafts being sleeved one around the other in a spaced apart manner, said at least one first dual directional electric generator including a first rotor that is connected to and rotatable along with said first rotary shaft in the first direction, and a second rotor that is connected to and rotatable along with said second rotary shaft in the second direction, said at least one first dual directional electric generator outputting an induced current when said first and second rotors are rotated relative to each other.
